(19) United States
(12) Patent Application Publication
(10) Pub. No.: US 2008/0276303 A1
(43) Pub. Date: Nov. 6, 2008

(54) Network Type Advertising

(75) Inventor: Matthew S. Gast, San Francisco, CA (US)

Correspondence Address: PERKINS COIE LLP, P.O. BOX 1208, SEATTLE, WA, 98111-1208, US

(73) Assignee: Trapeze Networks, Inc., Pleasanton, CA (US)

(21) Appl. No.: 12/113,535

(22) Filed: May 1, 2008

Related U.S. Application Data
(60) Provisional application No. 60/927,741, filed on May 3, 2007.
(60) Provisional application No. 60/973,413, filed on Sep. 18, 2007.

(51) Int. Cl. G06F 21/00; H04Q 7/00

(52) U.S. Cl. 726/3; 370/310

(57) ABSTRACT

A technique for network type awareness involves providing network type information associated with a wireless network to stations. The stations, or users of the stations, can then select which network best meets their needs.

### CROSS-REFERENCE TO RELATED APPLICATIONS

This application is a non-provisional application and claims priority to U.S. Provisional Patent Applications No. 60/927,741, filed May 3, 2007, and entitled “Network Type Selection” by Matthew Gast and No. 60/973,413 filed Sep. 18, 2007, and entitled “802.11u-Related Functionality” by Matthew Gast, both of which are incorporated by reference.

### BACKGROUND

Wireless networks allow users to eliminate messy cables and offer more mobility. For example, wireless networks allow users to connect to the Internet and work away from wired systems. Also, they provide a convenient tool for people to communicate with each other. As there are more wireless networks offered by many different sources and available to a user at certain locations, how to choose a wireless network that best suits the user's needs for specific information is an important issue as well as are compatibility issues when dealing with wireless networks.

Beacon frames are part of the IEEE 802.11 wireless network protocol. Beacon frames are frames that have control information, are transmitted, and help a wireless station to identify nearby wireless access points (AP) in a passive scanning mode. They tell nearby stations about the existence of the network. They can also be transmitted by an AP for polling purposes. The beacon frame sent by the AP contains control information and can be used by wireless stations to locate an AP if it is in an active scanning mode.

The beacon frame body may include, for example, a timestamp, beacon interval, capability information, a Service Set Identifier (SSID), a Frequency-Hopping (FH) Parameter Set, a Direct-Sequence (DS) Parameter Set, a Contention-Free (CF) Parameter Set, an Independent Basic Service Set (IBSS), and a Traffic Indication Map (TIM). However, the beacon frame does not normally include network type information that indicates what the networks offer in general.

### BRIEF DESCRIPTION OF THE DRAWINGS

FIG. 1 depicts an example of a system in which a station receives network type advertisements.

FIG. 2 depicts an example of a system in which a mobile device receives a network type advertisement from an access point (AP).

FIG. 3 depicts an example of a network type aware system.

FIG. 4 depicts a specific example of a probe response frame.

FIG. 5 depicts an example of network authentication type (NAT) frame.

FIG. 6 depicts an example of an alternative network type field for use in a probe response frame.

FIG. 7 depicts an example of a system for providing network type advertising for services.

FIG. 8 depicts a flowchart of an example of a method for connecting to an advertised

FIG. 9 depicts a flowchart of an example of a method for providing advertised services to a station.

### DETAILED DESCRIPTION

A technique for providing network type information is described.

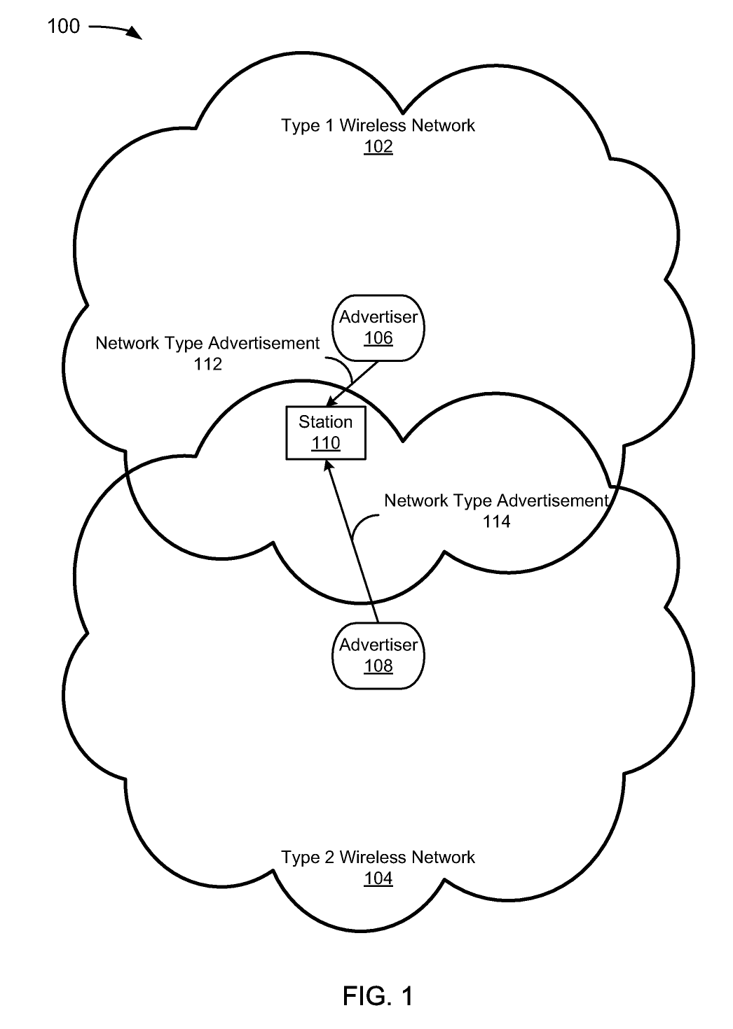

FIG. 1 depicts an example of a system 100 in which a station receives network type advertisements. The system 100 includes a Type 1 wireless network 102 and a Type 2 wireless network 104. The Type 1 wireless network 102 includes an advertiser 106 and the Type 2 wireless network 104 includes an advertiser 108. For illustrative purposes, a station 110 is located within range of the two wireless networks.

In the example of FIG. 1, the Type 1 wireless network 102 and the Type 2 wireless network 104 may be ad hoc or infrastructure networks. Ad hoc networks normally include stations that communicate directly with one another. Infrastructure networks normally include an access point (AP). An AP is a station that relays communications between other stations that are on the wireless network. Either or both of the wireless networks 102, 104 can include an ad hoc network or an infrastructure network.

For illustrative purposes, a Type 1 network can offer higher layer services including generic network access for a restricted user set, generic network access for a guest, VLAN tunneling, emergency voice services, emergency text alerts, network services for which charges apply, network services that are free, other known or convenient network layer services, and/or any other known or convenient higher layer services. The Type 1 network may or may not also offer lower layer services including distribution, integration, association, reassociation, disassociation, authentication, deauthentication, confidentiality and access control, MAC Service Data Unit (MSDU) delivery, Transmit Power Control (TPC), Dynamic Frequency Selection (DFS), other known or convenient link layer services, and/or any other known or convenient lower layer services. Type 1 and Type 2 networks may or may not offer the same or the same number of services, and may or may not have different service parameters or characteristics. Indeed, Type 1 and Type 2 networks may be identical, though it may sometimes be assumed in this paper that Type 1 and Type 2 networks have at least one difference in services to illustrate specific embodiments.

In the example of FIG. 1, the advertiser 106 is, for example, a station in the Type 1 wireless network 102. As such, if the Type 1 wireless network is an infrastructure network, the advertiser can include an AP. Similarly, the advertiser 108 may be an AP in the Type 2 wireless network 104. The advertisers 106, 108 know, or at least are capable of relaying, the network type of their respective wireless networks 102, 106.

In the example of FIG. 1, in operation, the advertiser 106 transmits a network type advertisement 112, which identifies the Type 1 wireless network 102 as Type 1, to the station 110. The advertiser 108 transmits a network type advertisement 114, which identifies the Type 2 wireless network 104 as Type 2, to the station 110. Advantageously, the station 10 (or a user of the station 110) can choose between the wireless networks 102, 104 before connecting to either of the wireless networks 102, 104. This can save time and resources.

It should be noted that the techniques described herein could be practiced with a single wireless network. In such a case, an advertiser may advertise the network type to a station. The station can then decide whether connecting to the network is desired based upon the network type.

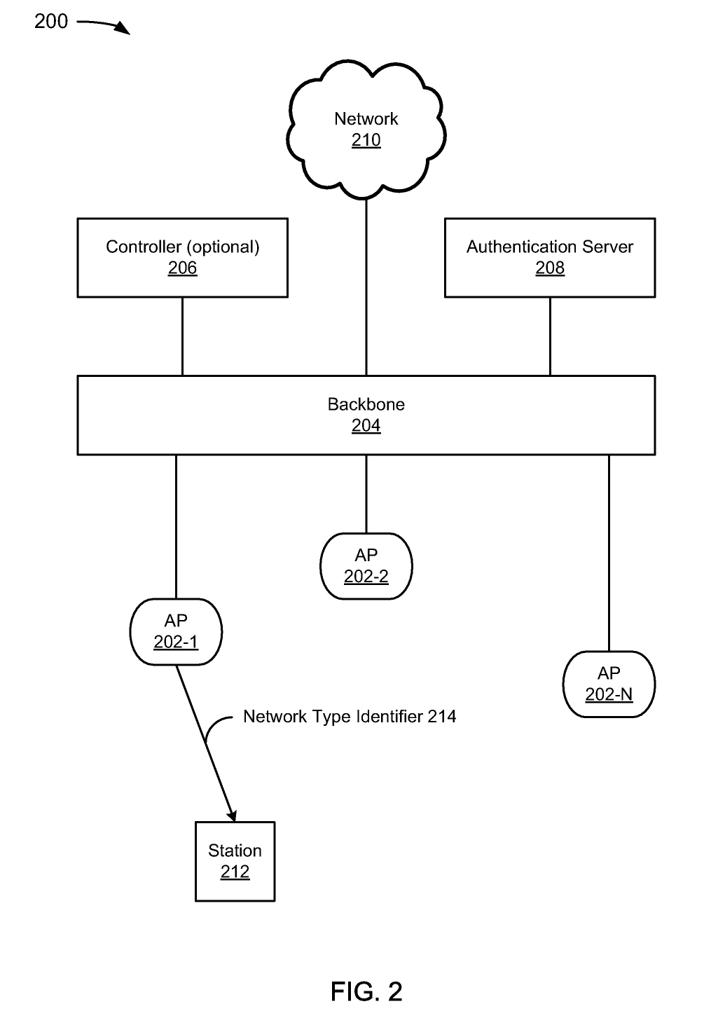

FIG. 2 depicts an example of a system 200 in which a mobile device receives a network type advertisement from an access point (AP). The system 200 includes AP 202-1 to 202-N (referred to collectively as APs 202), a backbone 204, a controller 206, an authentication server 208, and a network 210. For illustrative purposes, a station 212 is within range of one or more of the APs 202.

In the example of FIG. 2, the APs 202 may include any known or convenient station that serves as an intermediary between stations in a wireless network. The APs 202 can be compatible with any known or convenient wireless network protocol or standard, such as by way of example but not limitation, one or more of the 802.11 standards. The APs 202 can transmit, either by broadcast, multicast, or unicast, a network type identifier at the same or different times. Alternatively, only a subset of the APs 202, those designated “network type advertisers” are configured to transmit the network type identifier.

In the example of FIG. 2, the APs 202 are coupled to a backbone 204. While the backbone 204 is typically a backbone, the backbone technology may be wireless mesh technology such as 802.11s or any other known or convenient mesh standard.

In the example of FIG. 2, the APs 202 are coupled through the backbone 204 to the controller 206. It should be noted that the APs 202 and the controller 206 may be referred collectively as an authenticator. Authenticators that include APs and a controller can divide functionality between the APs and controller in a variety of ways. On one extreme, an AP can include all of the functionality of a controller (obviating the need for a separate controller, which is why the controller 206 is indicated to be optional) and on the other extreme, the AP can include no controller functionality.

The controller 206 can control any practical number of APs 202. The exact number of APs controlled by the controller 206 depends upon the implementation, embodiment, environment, or other factors, and may be completely arbitrary or random. In some implementations, an AP may have a primary controller and a backup controller. In this way, the AP can maintain contact with a controller by being controlled by the backup controller if the primary controller goes down. Although in the example of FIG. 2 only the controller 206 is depicted, different ones of the APs 202 can be controlled by different controllers within a single network, if configured appropriately.

In the example of FIG. 2, the APs 202 are coupled through the backbone 204 to the authentication server 208. It should be noted that the APs 202 could also be coupled through the controller 206 to the authentication server 208, though this is not depicted in the example of FIG. 2.

The authentication server 208 can be used during user authentication through one of the APs 202. There are various user authentication protocols that are used in practice, such as by way of example but not limitation the Extensible Authentication Protocol (EAP). 802.1x, for example, is based on EAP. However, any known or convenient user authentication protocol could be employed.

In sophisticated secure networks, user authentication can be done once for a given station, even if the station roams from one AP to another within a wireless network (and, depending upon the technology and implementation, even if the station roams to another wireless network). U.S. patent application Ser. No. 11/377,859, filed Mar. 15, 2006, and entitled “System and Method for Distributing Keys in a Wireless Network” by Dan Harkins, which is incorporated by reference, discloses one example of a system that enables a user to authenticate once, even when roaming between APs of a wireless network.

In the example of FIG. 2, the network 210 is coupled to the backbone 204. The network 210 can be any known or convenient network, including by way of example but not limitation a telephone network, the Internet, or some other network.

In the example of FIG. 2, in operation, the AP 202-1 (for example) transmits a network type identifier 214 to the station 212. Advantageously, after receiving the network type identifier 214 the station 212 (or a user associated with the station 212) can decide whether to attempt to connect to the wireless network based upon the information provided in the network type identifier 214.

In certain implementations the station 212 can receive network type identifiers from more than one of the APs 202. Assuming the network type identifiers are the same (e.g., because the APs 202 are all on the same wireless network), if the station 212 is configured properly, the identified wireless network will be displayed (if applicable) only once. Thus, a user will not typically be required to select between APs, but rather between networks. This redundancy avoidance can be accomplished with known or convenient techniques.

In certain implementations the network type identifier 214 identifies multiple wireless networks. The multiple wireless networks may be identified in a single network type identifier transmission or in multiple network type identifier transmissions. Multiple network type identifier transmissions may be sent in parallel (e.g., using different radios, or interleaving the signals) or serially (e.g., using the same radio). In either case, if properly configured, the station 212 can choose between wireless networks associated with the respective network identifiers.

In certain implementations, a first subset of the APs 202 can be associated with a first network, and a second subset of the APs 202 can be associated with a second network. The first and second subsets may be overlapping. The APs associated with more than one network can identify one or all of the networks with which they are associated in one or more network type identifier transmissions. The station 212 (or a user of the station 212) can then select between multiple networks that are identified by a single one of the APs 202.

In certain implementations, those of the APs 202 that send network type identifiers are a part of the identified network. However, strictly speaking, an AP could advertise a network with which it is not, or is only tenuously, associated. For example, a corporate network may include multiple virtual local area networks (VLANs). A first VLAN may be most closely associated with the controller 206, while a second VLAN may be most closely associated with some other controller (not shown). It may be desirable for one of the APs 202 to transmit a network type identifier associated with the second VLAN. Using, by way of example but not limitation VLAN tunneling, the station 212 can be connected to the second VLAN through one of the APs 202, even though the APs 202 are controlled by the controller 206, which is associated with the first VLAN. If the controller 206 is “smart” the VLAN tunneling may be transparent to the station 212.

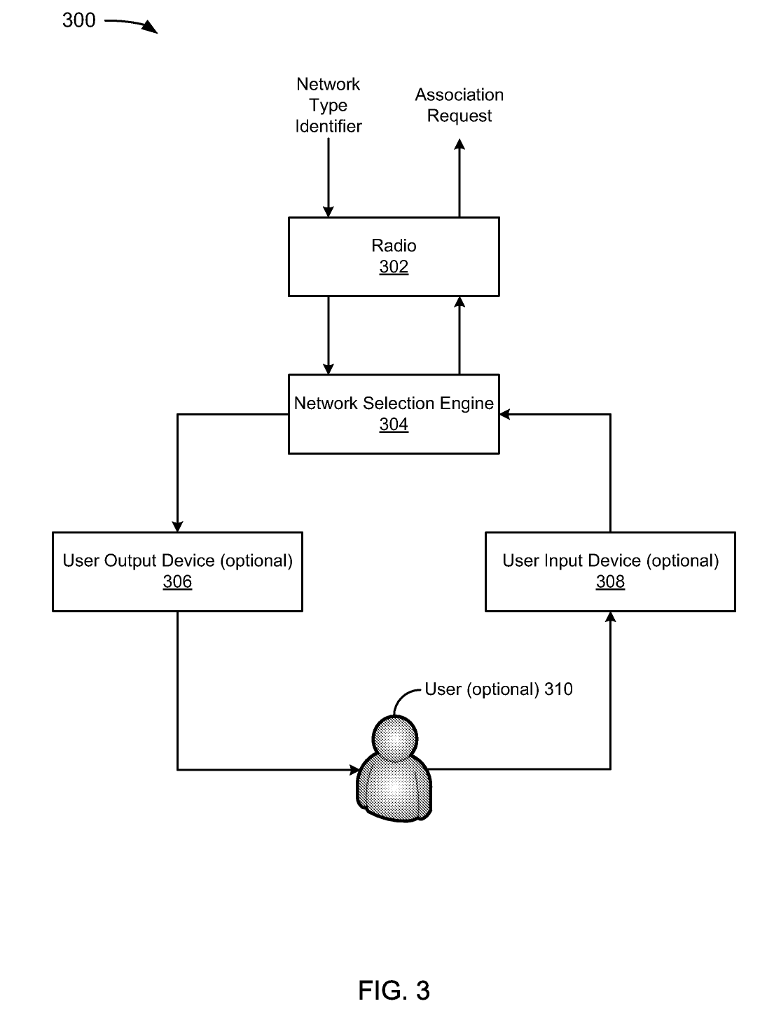

FIG. 3 depicts an example of a network type aware system 300. The system includes a radio 302, a network selection engine 304, an optional user output device 306, and an optional user input device 308. An optional user 310 is depicted for illustrative purposes.

In the example of FIG. 3, the radio 302 may include any known or convenient device capable of sending and receiving wirelessly. It may comprise a separate transmitter and receiver that are grouped logically for illustrative purposes, but more frequently it is implemented in silicon as a device capable of both transmission and receiving. There may be multiple radios on a station, but only one is depicted for illustrative purposes. A single radio (or chip) can be capable of single- or multi-modal wireless communications. A single mode is depicted for illustrative purposes.

In the example of FIG. 3, the network selection engine 304 can receive network type information from the radio and, if applicable, provide network type information to and receive a network selection from a user. The network selection engine provides the radio 302 with data the radio 302 needs to attempt association with a station, such as an AP, on the desired network. The network selection engine 304 can be implemented in a computer-readable medium such as, by way of example but not limitation, memory or storage of a known or convenient type. The network selection engine 304 can also include a processor that can utilize the memory or storage in a known or convenient manner. Depending upon the implementation, the processor can also control the radio 302, user output device 306, and/or user input device 308.

In the example of FIG. 3, the user output device 306 can be any known or convenient device for outputting data from the network selection engine 304. In the example of FIG. 3, the user input device 308 can be any known or convenient device for inputting data to the network selection engine 304. The user 310 can receive information from the network selection engine 304, such as a list of networks and a network type of one or more of the networks, via the user output device 306. The user 310 can then provide a network selection to the network selection engine 304 via the user input device 308. It may be noted that the user output device 306, user input device 308, and user 310 are optional. That is because a station can decide upon a network without user knowledge or input, assuming the station is appropriately configured. It should be noted that the user 310 could accomplish the configuration (using at least the user input device 308) in advance of receipt of the network type identifier, or the configuration could be accomplished in some other known or convenient manner (e.g., by an administrator prior to deploying a station, by a software provider prior to distributing software used by the network selection engine 304, at a factory prior to distributing the station, etc.).

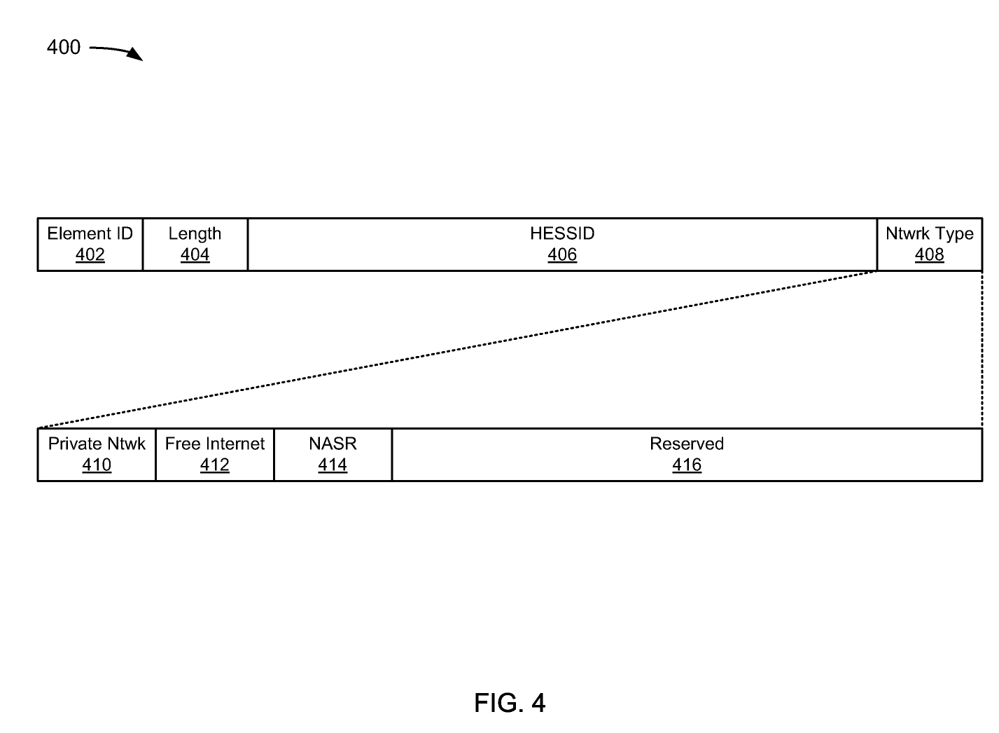

In the example of FIG. 3, in operation, the radio 302 receives a network type identifier. The network type identifier can be sent as an advertisement, as part of a beacon frame, or in some other known or convenient manner. The network type identifier can also be sent as a response, such as by way of example but not limitation a probe response, to a previous query (or probe) from the radio 302. An example of a component of a probe response frame is depicted in FIG. 4, which is described later. It may be noted that prior to the probe request, there could have been prior communications between the radio 302 and, e.g., an AP, such as a method that allows a client device to establish a single security association to a network (e.g., 802.11 preauthentication, 802.11r, or as implemented in some other standard).

Regardless of the manner in which the radio 302 receives the network type identifier, the network type identifier is provided to the network selection engine 304. The network selection engine 304 can send the network type identifier (or data associated with the identified network) to the user 310 via the user output device 306 and receive a selection from the user 310 via the user input device 308. However, the network selection engine 304 can instead (or in addition) be capable of selecting a network that meets certain pre-determined or dynamically determined criteria. Also, prior to sending data to the user 310, if applicable, the network selection engine 304 can do some pre-processing to eliminate network choices that are determined to be less preferable, or the network selection engine 304 can rank networks for the convenience of the user 310 (e.g., the networks the network selection engine 304 determines to be preferable can be put higher in a list than networks the network selection engine 304 determines to be less preferable). The network selection engine 304 may wait a reasonable amount of time to see if any other network type identifiers are received on the radio 302. When a selection has been made, the network selection engine 304 has the radio 302 send an association request to the selected network. In some implementations, the radio 302 may transmit something other than an association request; any known or convenient technique can be used to join the selected network.

FIG. 4 depicts a specific example of a component of a probe response frame 400 component. The probe response frame 400 can include more fields than are depicted. The frame 400 includes an element ID field 402, a length field 404, a homogenous extended service set identifier (HESSID) field 406, and a network type field 408. As FIG. 4 depicts a specific example, it should be recognized that there are a nearly unlimited number of ways to configure a probe response frame, or other advertisement mechanism. It is likely, at least in the case of commercial products, that the mechanism will conform to existing standards, though this is not required. Moreover, a frame used in an actual implementation can include fewer or more fields than are indicated in the probe response frame 400, and may or may not be referred to as a “frame.”

In the example of FIG. 4, the element ID field associates the probe response frame 400 with an information element in a known or convenient manner. For example, TABLE 1: Element IDs lists multiple information elements and their element IDs.

TABLE 1
Element IDs

| Information Element | Element ID |
|---|---|
| Interworking Capability | X |
| GAS Capability | X + 1 |
| Advertisement Protocol | X + 2 |
| GAS Request | X + 3 |
| GAS Response | X + 4 |
| GAS Traffic Indication Map | X + 5 |
| GAS Comeback Delay | X + 6 |
| HESSID | X + 7 |
| QoS Map Set | X + 8 |
| Expedited Bandwidth Request Element | X + 9 |
| SSID Container Element | X + 10 |
| Reserved | X + 11 to X + 220 |

In this specific example, the element ID associated with the HESSID information element can be put in the HESSID field. It may be noted that this table is from IEEE P802.11u™/D0.04, which is an unapproved IEEE Standards Draft, subject to change, and is intended to serve as a non-example limiting example of how an element ID could be selected.

The Element IDs in Table I have the value X+n, where X is a placeholder value. If Element IDs were actually assigned in the context of 802.11, they would be inserted into the Element IDs table of 802.11 (in any order). See, e.g., Table 7-26-Element IDs of IEEE Std 802.11-2007.

In the example of FIG. 4, the length field 404 can include any known or convenient value associated with a length of the frame 400, or a portion thereof, or some other size or count. In a specific example, the length field 404 can have a length of 6, as is the case in IEEE P802.11u™/D0.04. A reason for this value is that the HESSID field 406 is 6 octets and the network type field 408 is 1 octet long. The size of the frame following the length field 404 is, therefore, 7 octets. Length, in this specific example, is the size in octets of the frame following the length field 404, minus 1.

In the example of FIG. 4, the HESSID field 406 can specify the definition of HESSID. For example, in an infrastructure mode, the HESSID definition can include a basic service set identifier (BSSID) value of one group of APs. The HESSID and SSID together provide a unique value that can be advertised in beacons and probe responses so that, for example, a non-AP station is aware of continued applicability of previously discovered interworking and advertising services when moving from one AP to another within the scope of the HESSID.

In the example of FIG. 4, the network type field 408 is used to advertise the type of network. In a specific example, the network type field 408 advertises the type of network to every SSID included in the HESSID set. The network type field 408 includes a private network bit 410, a free Internet access bit 412, a next authentication step required bit 414, and reserved bits 416. The private network bit 410, if set, advertises that the networks in the HESSID require user accounts. The free Internet access bit 412, if set, advertises that the network supports free access and that users attaching to the network may reach the Internet. The NASR bit 414, if set, advertises that the network requires a further authentication step, such as UAM, EAPOL, or any other available native info authentication type for which the network is configured. The reserved bits 416 can be set to zero, but could, of course, be used for any other desired known or convenient network type that might be of interest to a non-AP station in deciding whether to associate with the network.

It may be noted that the probe response frame may be different depending upon implementation. For example, an alternative probe response frame is depicted later in FIG. 10.

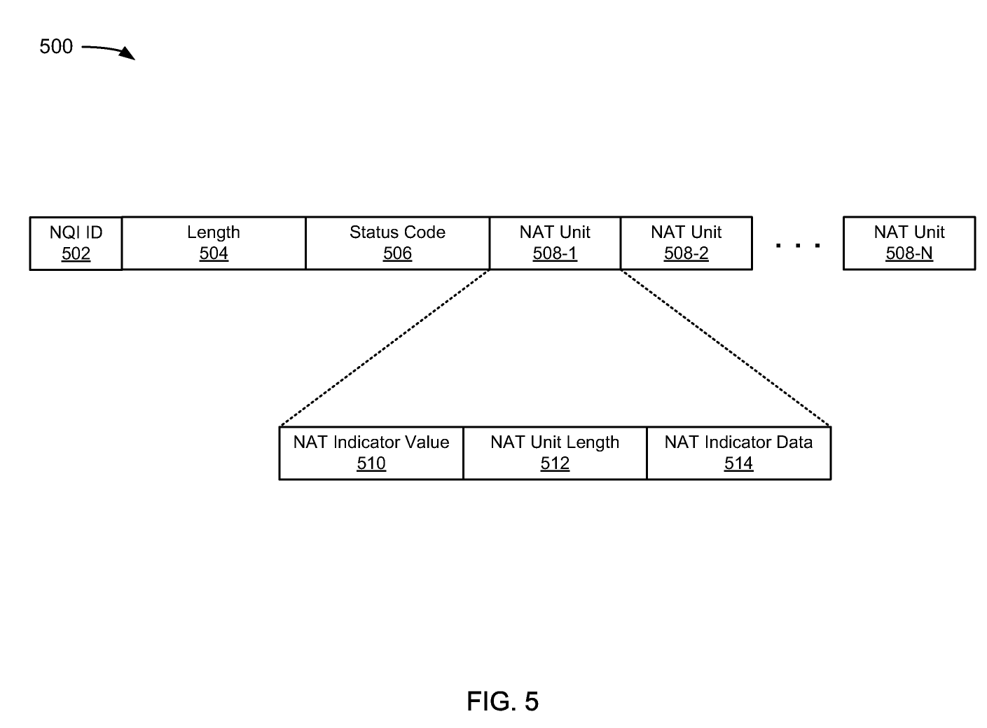

FIG. 5 depicts an example of network authentication type (NAT) frame 500. The NAT frame 500 provides a relatively straight-forward listing of the authentication types that are used on a particular SSID in a specific implementation. The NAT frame 500 includes a native query info ID (NQI ID) field 502, a length field 504, a status code 506, and NAT unit 508-1 to NAT unit 508-N (referred to collectively as NAT units 508). In an actual implementation, the NAT frame 500 may include more or fewer fields, and may or may not be referred to as a “frame.”

In the example of FIG. 5, the NQI ID field 502 identifies the frame 500 in accordance with a known or convenient identification scheme. For example, TABLE 2: NQI ID Definitions includes multiple NQI IDs and their meanings.

TABLE 2
NQI ID Definitions

| NQI ID | Meaning |
|---|---|
| 0 | Capability List |
| 1 | mSSID List |
| 2 | Emergency Networks List |
| 3 | NAT |
| 4-255 | Reserved |

In this specific example, the NQI ID associated with the NAT meaning, or ‘3’, can be put in the NQI ID field 502. It may be noted that this table is from IEEE P802.11u™/D0.04, and is intended to serve as a non-limiting example of how an NQI ID could be selected.

In the example of FIG. 5, the length field 504 can define the size of the NAT element and is determined by the number and size of the NAT units 508. In from IEEE P802.11u™/D0.04, for example, the length field 504 is two octets.

In the example of FIG. 5, the status code field 506 includes a value associated with a meaning that is depicted in TABLE 3: Status Codes.

TABLE 3
Status Codes

| Status Code | Meaning |
|---|---|
| 52 | No outstanding GAS request |
| 53 | GAS Query Protocol(s) not supported |
| 54 | GAS Response not received from the server in the network |
| 55 | GAS Query Response larger than permitted per |
| | configured AP policy |
| 56 | Advertising server in the network is not currently reachable |
| 57 | Requested information is not configured for this BSS |
| 58-65535 | Reserved |

In this specific example, the status code associated with the appropriate meaning can be put in the status code field 506. It may be noted that this table is from IEEE P802.11u™/D0.04, and is intended to serve as a non-limiting example of how a status code could be selected. In the IEEE P802.11u™/D0.04, the status code field 506 is two octets.

In the example of FIG. 5, the NAT units 508 can include NATs available in a wireless network. The number of NAT units 508 is implementation-specific. The size of the NAT units 508 is also implementation-specific and one of the NAT units 508 may different from another of the NAT units 508. In other words, the NAT units 508 can have variable size. It may be noted that although the NAT units 508 are depicted as relatively small compared to the other fields of the frame 500, in some implementations, one or more of the NAT units 508 are actually relatively large compared to the other fields of the frame 500.

An example of one of the NAT units 508 includes a NAT indicator value field 510, a NAT unit length field 512, and NAT indicator data 514. In a specific example, the NAT indicator value field 510 has one of the values shown in TABLE 4: NAT indicator Values.

TABLE 4
NAT Indicator Values

| NAT | |
|---|---|
| Indicator Value | Meaning |
| 0 | Acceptance of legal terms and conditions |
| 1 | On-line enrollment supported |
| 2 | HTTP or HTTPS redirect |
| 3 | 802.1X |

It may be noted that this table is from IEEE P802.11u™/D0.04, and is intended to serve as a non-limiting example of NAT indicator values. In this specific example, a value of ‘2’ in the NAT indicator value field 510 indicates that the NAT unit is associated with HTTP or HTTP redirect. This method of authentication is widely used by captive web portals such as the universal access method (UAM) or the open source NoCatAuth. However, any known or convenient method of authentication could be used, depending upon implementation.

In a specific example, the NAT unit length field 512 is set to the number of octets in the NAT unit 508.

In a specific example, the NAT indicator data field 514 can include additional data. The NAT indicator data field 514 is a variable length field in IEEE P802.11u™/D0.04, though this is intended to serve as a non-limiting example of the size of the NAT indicator data field 514. If, for example, the NAT unit 508 is associated with UAM, then the NAT indicator data field can include the UAM version. In a specific example, the UAM version can be 1 octet in size, which means the NAT unit length field 512 can be set to ‘2’. If, on the other hand, the NAT unit 508 is associated with 802.1X, then the NAT indicator data field 514 can describe, for example, an Extensible Authentication Protocol (EAP) type that is in use.

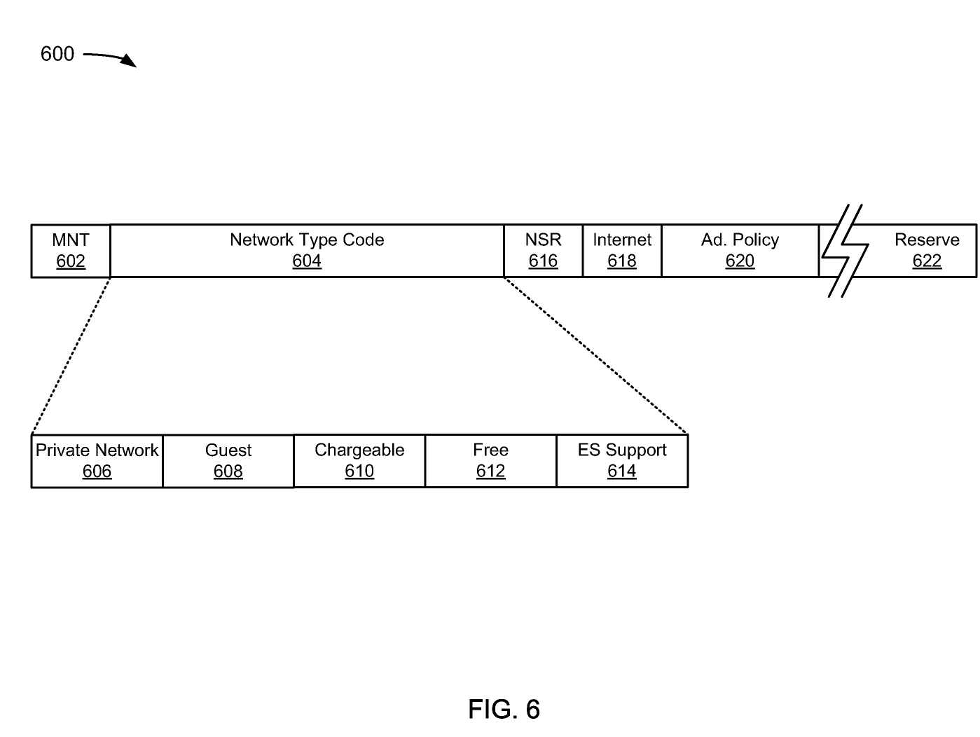

FIG. 6 depicts an example of an alternative network type field 600 for use in a probe response frame. (See, e.g., FIG. 4, network type field 408.) The field includes a multiple network types (MNT) bit 602, a network type code 604, a next step required (NSR) bit 616, an Internet bit 618, advertisement policy bits 620, and a reserved data bit field 622. In the example of FIG. 6, the MNT bit 602 indicates whether there are multiple different types of networks in the set of networks.

In the example of FIG. 6, the network type code 604 includes five bits associated with five network type categories: (1) a private network bit 606, which, if set, indicates at least one network requires a user account for network access, (2) a guest bit 608, which, if set, indicates user accounts are required, but guest accounts are available on at least one network, (3) a chargeable bit 610, which, if set, indicates access to the network requires payment (further information on types of charges may be available through other methods such as by way of example but not limitation 802.21, UAM, etc.), (4) a free bit 612, which, if set, indicates at least one network does not charge for access, (5) an emergency services (ES) support bit 614, which, if set, indicates at least one network supports emergency services, which may be provided through an emergency services only (ESO) network or a network that provides ES access with public credentials.

In the example of FIG. 6, the NSR bit 616 indicates whether the network requires a further step. This step may be part of a preauthentication process, an association process, an authentication process, or some other process or portion of a process that a station must take before joining the relevant wireless network.

In the example of FIG. 6, the Internet bit 618 indicates whether the network provides Internet access. In this way, stations can learn before association with a station (e.g., an AP) of a wireless network whether they will be able to access the Internet through the wireless network.

In the example of FIG. 6, the advertisement policy field 620 can indicate whether the network (1) does not require the end user to view commercial advertisements, (2) requires end users to view advertisements, or (3) requires end users to view advertisements, but only for certain services. In this way, networks can provide advertisements to, for example, earn advertisement revenue, but notify stations that advertisements are provided prior to association.

In the example of FIG. 6, the reserved data field 622 can be set to zero.

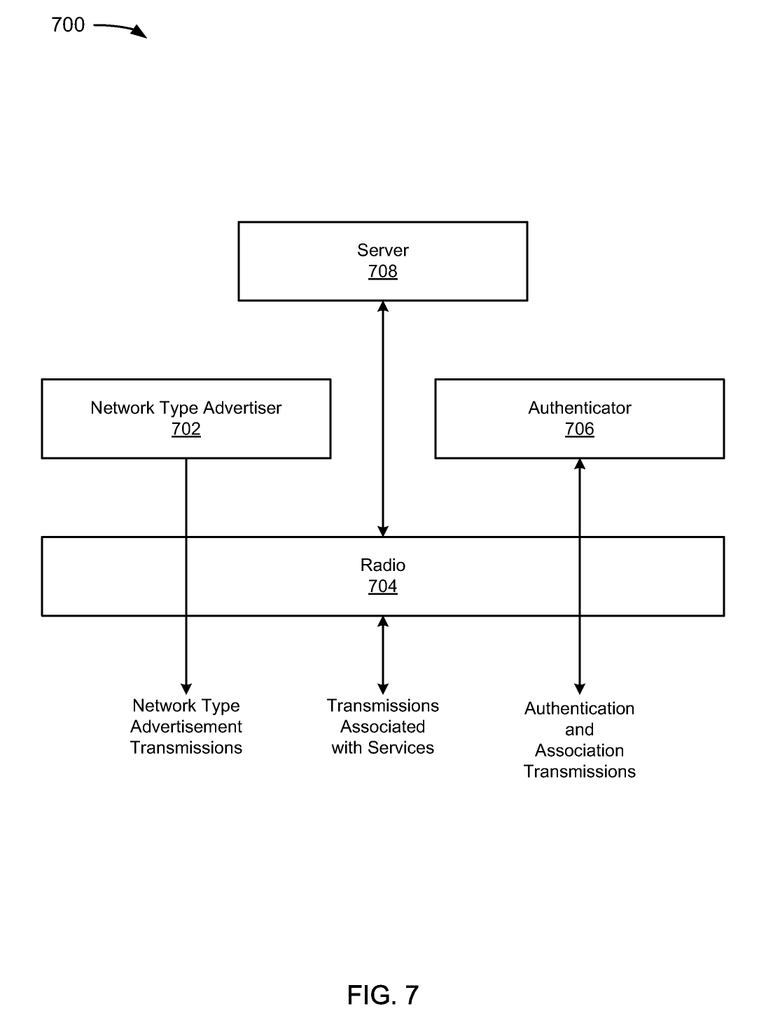

FIG. 7 depicts an example of a system 700 for providing network type advertising for services. The system 700 includes a network type advertiser 702, a radio 704, an authenticator 706, and a server 708.

In the example of FIG. 7, the network type advertiser 702 knows characteristics of a network such as those described by way of example with reference to FIG. 6. This knowledge may be provided to the network type advertiser 702 in a known or convenient manner. The network type advertiser 702 can be implemented in a computer-readable medium, such as computer storage or memory coupled to a processor.

In the example of FIG. 7, the radio 704 can be a radio of known or convenient type.

In the example of FIG. 7, the authenticator 706 can perform procedures that enable a station to connect to a network. Such procedures may include by way of example but not limitation preauthentication, association, and authentication procedures. The authenticator 706 can be implemented on a single device (e.g., a station in an ad hoc network) or implemented across multiple devices (e.g., on an AP, controller, and authentication server in an 802.11 network).

In the example of FIG. 7, the server 708 can provide services to stations that are connected to the network. Any known or convenient services can be provided by the server 708, such as by way of example but not limitation Internet access, emergency service access, etc.

In the example of FIG. 7, in operation, the network type advertiser 702 provides the radio 704 with data sufficient to enable transmission of a network type advertisement. The transmission may be by a known or convenient mechanism, such as by way of example but not limitation a beacon frame, a probe response frame, or some other data structure. Although the term “frame” is used in the example of FIG. 7, it should be noted that any data structure could be used instead such as a packet or datagram.

A station that receives the network type advertisement can determine whether the system 700 provides a network of a type that is desirable. If the station opts to join the advertised network, the radio 704 will receive an association request frame, or an equivalent data structure, from the station. The authenticator 706 and the station communicate through the radio 704 until authentication and association are complete. Then the station may be referred to as “on” the network.

Once a station is one the network, the server 708 can provide services to the station. These services are presumably provided in accordance with the advertised network type. In some implementations, there may be ways to ensure that the advertised network and the actual network are the same, though in less strict systems it might be possible to “lie.” In this paper, for the most part, it is assumed that the services provided are as advertised.

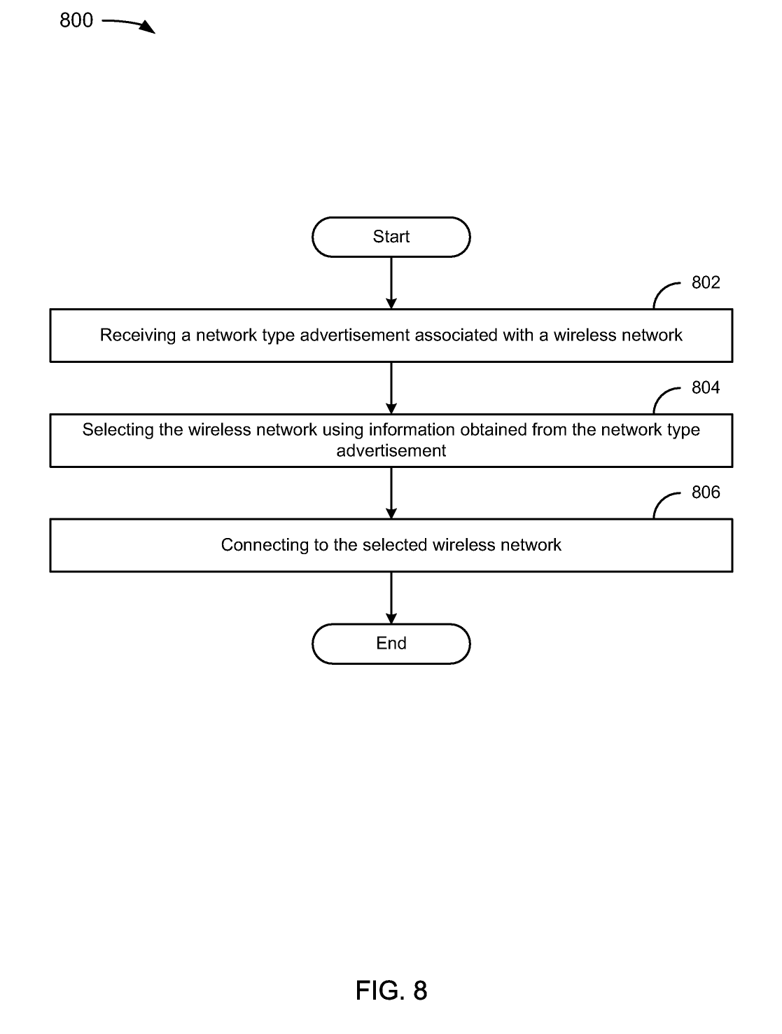

FIG. 8 depicts a flowchart 800 of an example of a method for connecting to an advertised network. It is expected, though not required, that at the start of the flowchart 800 a station will not be connected to the advertised network, and at the end of the flowchart 800, the station will be connected.

In the example of FIG. 8, the flowchart 800 starts at module 802 with receiving a network type advertisement associated with a wireless network. Presumably the network type advertisement is received at a station. The station may or may not be configured to or capable extracting the network type information to facilitate selection of a network of a desired type, displaying the network type information to facilitate selection of a network of a desired type by a user, or both. However, the described method is not particularly useful unless the station is capable of using the advertised information; so the capability is presumed for illustrative purposes.

The network type information may include venue type information, e.g. a venue's name, and a station's interworking attributes. The venue type information may be useful in determining the characteristics of the wireless network, and could include venue group information, e.g. assembly, business, educational, factory or industrial, institutional, mercantile, residential, storage, utility, vehicular, outdoor, etc. Further, the venue type information could be more specific, e.g. arena, stadium, passenger terminal, amphitheater, amusement park, church, convention center, library, museum, restaurant, theater, zoo or aquarium under the venue group assembly.

In the example of FIG. 8, the flowchart 800 continues to module 804 with selecting the wireless network using information obtained from the network type advertisement. The station may make the selection or the station may enable a user to make the selection (with or without preprocessing). The station may receive multiple network type advertisements. For illustrative purposes, it is assumed that the advertised network (802) is the one that is selected at module 804.

In the example of FIG. 8, the flowchart 800 ends at module 806 with connecting to the selected wireless network. The connection may be accomplished in accordance with known or convenient mechanisms.

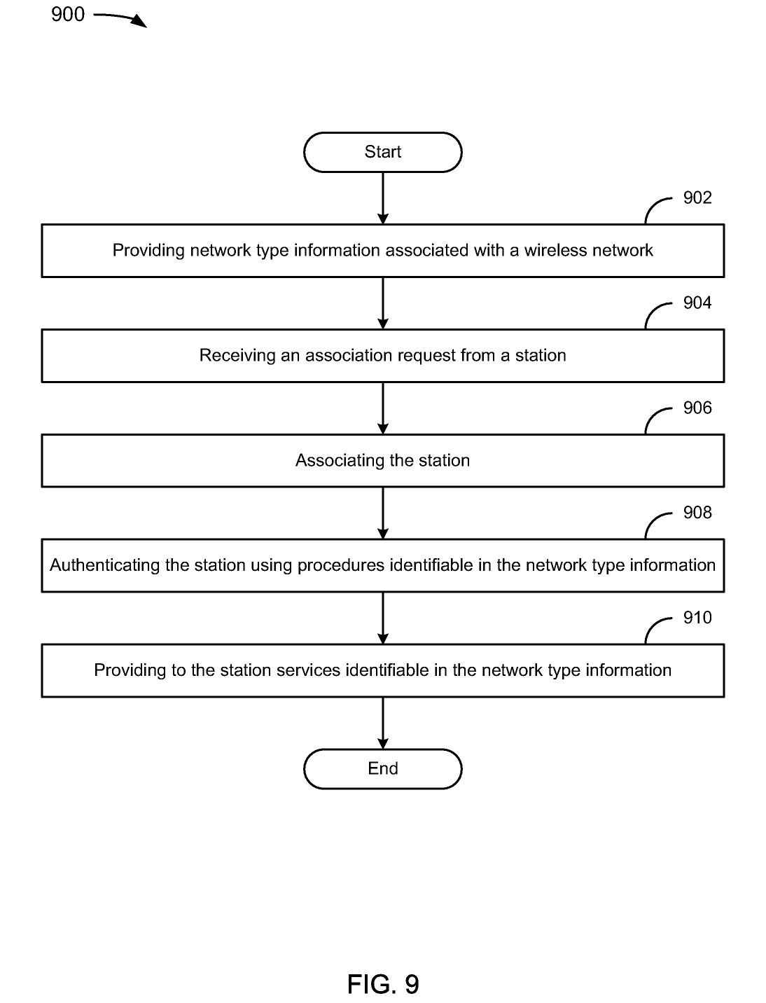

FIG. 9 depicts a flowchart 900 of an example of a method for providing advertised services to a station. Prior to the start of the flowchart 900, it is possible that preauthentication activities will have already taken place.

In the example of FIG. 9, the flowchart 900 starts at module 902 with providing network type information associated with a wireless network. The network type information may describe what a wireless network offers, as well as describe the wireless network in other ways.

In the example of FIG. 9, the flowchart 900 continues to module 904 with receiving an association request from a station. While in accordance with some standards, such as 802.11, association requests are used, it should be noted that in a system that does not use association requests, the module 904 may be ignored.

In the example of FIG. 9, the flowchart 900 continues to module 906 with associating the station. Again, this assumes that association is required.

In the example of FIG. 9, the flowchart 900 continues to module 908 with authenticating the station using procedures identifiable in the network type information. Advantageously, since the procedures are identifiable, it is probably less likely that a station will fail authentication; if the station was aware of the procedures beforehand, it probably could verify whether authentication would succeed without attempting to authenticate, at least in some cases.

In the example of FIG. 9, the flowchart 900 continues to module 910 with providing to the station services identifiable in the network type information. Advantageously, since the services are identifiable, it is more likely that the services will be desired by a user of the station; if the station was aware of the services beforehand, it probably could verify whether the services were desirable prior to authenticating, at least in some cases.

FIG. 10 depicts an example of an alternative probe frame response 1000 implementation. (FIG. 7-95an)

FIG. 11 depicts an example of network metadata that can be included in the alternative frame response 1000 (FIG. 10). (FIG. 7-36t)

The term “subset,” as used herein, refers to a subset of a set of elements. The group can include none, one, some, or all of the elements. Thus, the term is used in a manner that is consistent with standard mathematical usage.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system comprising:
a network type advertiser;
a radio coupled to the network type advertiser;
an authenticator coupled to the radio;
wherein, in operation, the network type advertiser provides the radio with sufficient data to transmit a network type advertisement to a station and the authenticator facilitates a connection by the station to the advertised network through the radio.

2. The system of claim 1, wherein the authenticator includes:
an access point (AP);
a controller coupled to the AP;
an authentication server coupled to the controller;
wherein, in operation, the AP transmits the network type advertisement, the controller and the AP facilitate association of the station with the advertised network, and the AP, controller, and authentication server facilitate authentication of the station in accordance with a network authentication type (NAT) provided in the network type advertisement.

3. The system of claim 1, further comprising an authentication server that requires a next authentication step from the station, as indicated in the network type advertisement.

4. The system of claim 1, further comprising a server that provides services to the station in accordance with the network type advertisement.

5. The system of claim 1, further comprising a server that provides emergency services in accordance with an emergency services support indicator provided in the network type advertisement.

6. The system of claim 1, further comprising a server that provides Internet services in accordance with an Internet access indicator provided in the network type advertisement.

7. The system of claim 1, further comprising a server that provides paid services in accordance with a chargeable services indicator provided in the network type advertisement.

8. The system of claim 1, further comprising a server that provides free services in accordance with a free services indicator provided in the network type advertisement.

9. A method comprising:
providing network type information associated with a wireless network;
authenticating a station in accordance with a network authentication type (NAT) identifiable in the network type information;
providing to the station services identifiable in the network type information.

10. The method of claim 9, further comprising providing the network type information in a beacon frame.

11. The method of claim 9, further comprising providing the network type information in a probe response.

12. The method of claim 9, further comprising:
receiving an association request from the station;
associating the station.

13. The method of claim 9, further comprising making a guest account available in accordance with the network type information.

14. The method of claim 9, further comprising charging an account associated with the station for services provided, wherein the chargeable nature of the services is indicated in the network type information.

15. The method of claim 9, further comprising emergency support services, wherein availability of the emergency support services is identifiable in the network type information.

16. The method of claim 9, further comprising carrying out a next authentication step in accordance with a next authentication step required indicator in the network type information.

17. A method comprising:
receiving a network type advertisement associated with a wireless network;
selecting the wireless network using information obtained from the network type advertisement;
connecting to the selected wireless network.

18. The method of claim 15, further comprising:
probing the wireless network;
receiving the network type advertisement in a probe response.

19. The method of claim 15, wherein the information includes an indication that the wireless network is a private network, wherein connecting to the selected wireless network includes providing information associated with a user account.

20. The method of claim 15, wherein the information includes an indication that a next step is required, wherein connecting to the selected wireless network includes taking the indicated next step.
